(19) United States
(12) Patent Application Publication
(10) Pub. No.: US 2011/0078784 A1
(43) Pub. Date: Mar. 31, 2011

(54) VPN SYSTEM AND METHOD OF CONTROLLING OPERATION OF SAME

(75) Inventor: Hiroshi OHTANI, Ashigarakami-gun (JP)

(73) Assignee: FUJIFILM Corporation, Tokyo (JP)

(21) Appl. No.: 12/893,780

(22) Filed: Sep. 29, 2010

(30) Foreign Application Priority Data
Sep. 30, 2009 (JP) 2009-226334

(51) Int. Cl. G06F 21/00

(52) U.S. Cl. 726/15

(57) ABSTRACT

A VPN management server transmits a seed to a client computer and VPN server. The client computer generates a VPN password from the seed using a prescribed algorithm and transmits the generated VPN password to the VPN server. The VPN server generates a password from the seed using an algorithm identical with the prescribed algorithm in the client computer. If the VPN password transmitted from the client computer and the VPN password generated in the VPN server match, the VPN server allows utilization of the VPN by reason of the fact that the client computer has been authenticated. Even if leakage of the seed occurs, the VPN password will not be generated unless the algorithm is analyzed. The result is enhanced security.

### BACKGROUND OF THE INVENTION

1. Field of the Invention

This invention relates to a VPN system and to a method of controlling the operation thereof.

2. Description of the Related Art

Owing to expansion of Internet broadband and lower server cost, outsourcing services such as rental servers, server hosting and serving housing are continuing to mature as an infrastructure industry. In these outsourcing services, a server is connected to the Internet and is assigned a global IP address.

However, as long as a server is connected to the Internet, it can be connected to from everywhere in the world. As a consequence, a user other than one allowed to utilize the server can access the server merely by cracking the password used in authentication. Thus it is technically difficult to limit utilization of the server in an outsourcing service solely to a specific user.

A VPN (Virtual Private Network) is in use for this reason. A VPN enables a private network to be constructed on the Internet so that a public line can be utilized in the manner of a virtual leased line. By virtual tunneling between communicating parties, communication by private address which intrinsically cannot be achieved via the Internet becomes possible.

Systems utilizing such a VPN include one which transmits a VPN password to a terminal device (see the specification of Japanese Patent Application Laid-Open No. 2001-197058) and one which alleviates VPN management load (see the specification of Japanese Patent Application Laid-Open No. 2003-188901), by way of example.

However, security in cases where a specific user is allowed to utilize a VPN is not very robust in these systems.

### SUMMARY OF THE INVENTION

Accordingly, an object of the present invention is to improve security in a case where a specific user is allowed to utilize a VPN.

The present invention relates to a VPN system that includes a VPN management server, a client computer and a VPN server.

The VPN management server includes: a seed generating device (means) for generating a seed, which is a character string for creating a VPN password for verifying authorization to utilize a VPN by which the client computer communicates with the VPN server via a VPN tunnel; a first seed transmitting device (means) for transmitting the seed generated by the seed generating device to the client computer via the Internet; and a second seed transmitting device (means) for transmitting the seed generated by the seed generating device to the VPN server via a LAN.

The client computer includes: a first VPN password generating device (means) for generating a VPN password by a first prescribed algorithm using the seed transmitted from the first seed transmitting device of the VPN management server; and a VPN password transmitting device (means) for transmitting the VPN password generated by the first VPN password generating device to the VPN server.

The VPN server includes: a second VPN password generating device (means) for generating a VPN password by an algorithm identical with the first prescribed algorithm, by which the client computer generates the VPN password using the first VPN password generating device, using the seed transmitted from the second seed transmitting device of the VPN management server; and a VPN authentication device (means) for allowing utilization of the VPN by the client computer in response to a match between the VPN password generated by the second VPN password generating device and the VPN password transmitted from the VPN password transmitting device of the client computer.

The present invention also provides a method of controlling the operation of the above-described VPN system. Specifically, the invention provides a method of controlling operation of a VPN system that includes a VPN management server, a client computer and a VPN server.

The VPN management server generates a seed, which is a character string for creating a VPN password for verifying authorization to utilize a VPN by which the client computer communicates with the VPN server via a VPN tunnel, and transmits the generated seed to the client computer via the Internet and to the VPN server via a LAN.

The client computer generates a VPN password by a first prescribed algorithm using the seed transmitted from the VPN management server, and transmits the generated VPN password to the VPN server.

The VPN server generates a VPN password by an algorithm identical with the first prescribed algorithm, by which the client computer generates the VPN password, using the seed transmitted from the VPN management server, and allows utilization of the VPN by the client computer in response to a match between the generated VPN password and the VPN password transmitted from the client computer.

In accordance with the present invention, a seed for creating a VPN password is generated in a VPN management server. The generated seed is transmitted from the VPN management server to the client computer and VPN server. In the client computer that has received the seed, a VPN password is generated from the seed by a first prescribed algorithm. The generated VPN password is transmitted from the client computer to the VPN server. In the VPN server that has received the seed, a VPN password is generated using an algorithm identical with the first prescribed algorithm for generating the VPN password in the client computer. If the VPN password generated in the VPN server matches the VPN password generated in the client computer and transmitted from the client computer, then the client computer is allowed to access the VPN server and to utilize the VPN. Even if the seed is stolen, the VPN server cannot be accessed unless the first prescribed algorithm for generating the VPN password from the seed is analyzed. The result is enhanced security.

The client computer further includes: a first authentication code generating device (means) for generating an authentication code (digest) obtained by encrypting a prescribed code for encryption by a second prescribed algorithm using a VPN management server key specific to the VPN management server; and a code transmitting device (means) for transmitting the authentication code generated by the first authentication code generating device and the prescribed code for encryption to the VPN management server.

The VPN management server further includes: a VPN management server key storage device (means) for storing the VPN management server key; a second authentication code generating device (means) for generating an authentication code obtained by encrypting the prescribed code for encryption, which has been transmitted from the code transmitting device and used in generating the authentication code in the first authentication code generating device, by an algorithm identical with the second prescribed algorithm in the first authentication code generating device using the VPN management server key that has been stored in the VPN management server key storage device; and a client authentication device (means) for authenticating the client by a match between the authentication code generated by the second authentication code generating device and the authentication code transmitted from the authentication code transmitting device of the client computer.

The first seed transmitting device of the VPN management server transmits the seed, which has been generated by the seed generating device, to the client computer via the Internet, in response to authentication of the client by the client authentication device, by way of example.

The prescribed code for encryption is at least one of a client code, which identifies the client computer, and a salt, which is a random character string.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a VPN system;

FIG. 2 illustrates an example of a VPN setup table;

FIG. 3 illustrates an example of client computer/VPN management server transmission data;

FIG. 4 illustrates an example of VPN management server/VPN server transmission data;

FIG. 5 illustrates an example of VPN management server/client computer transmission data;

FIG. 6 illustrates an example of client computer/VPN server transmission data;

FIG. 7 is a flowchart illustrating processing executed by a client computer;

FIG. 8 is a flowchart illustrating processing executed by a VPN management server;

FIG. 9 is a flowchart illustrating processing executed by a VPN management server;

FIG. 10 is a flowchart illustrating processing executed by a VPN server; and

FIG. 11 is a flowchart illustrating processing executed by a VPN server.

### DESCRIPTION OF THE PREFERRED EMBODIMENTS

A preferred embodiment of the present invention will now be described with reference to the drawings.

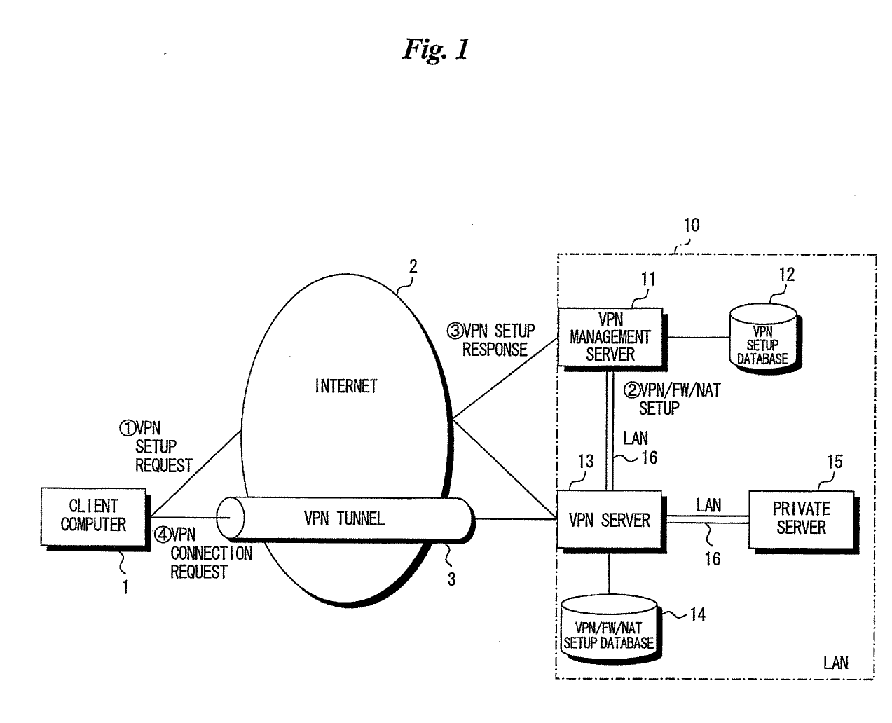

FIG. 1 illustrates an overview of a VPN system according to an embodiment of the present invention.

The VPN system includes a VPN management server 11, a VPN server 13 and a private server 15, all of which exist in a local area 10. The VPN management server 11 and VPN server 13 are connected by a LAN (Local-Area Network) 16. Further, the VPN server 13 and private server 15 are connected by the LAN 16. Connected to the VPN management server 11 is a VPN setup database 12 that stores a VPN setup table containing information necessary for setting up a VPN, as will be described in detail later. Further, connected to the VPN server 13 is a VPN/FW/NAT setup database 14 that stores information for setting up a VPN/FW (Fire Wall)/NAT (Network Address Translation).

The VPN management server 11 and VPN server 13 are capable of communicating with a client computer 1 via Internet 2. When the client computer 1 is allowed to utilize the VPN, it becomes possible for the client computer 1 and VPN server 13 (private server 15) to communicate utilizing a VPN tunnel 3, as will be described in detail later.

The client computer 1, VPN management server 11, VPN server 13 and private server 15 all have a CPU, a communication circuit, a memory, a hard-disk drive, a keyboard and mouse and a timer, etc. Processing, described later, such as seed generation processing, VPN password generation processing and authentication processing basically is executed by the CPUs of the client computer 1, VPN management server 11 and VPN server 13. Dedicated devices such as a seed generating device, VPN password generating device and authentication device may be provided as a matter of course.

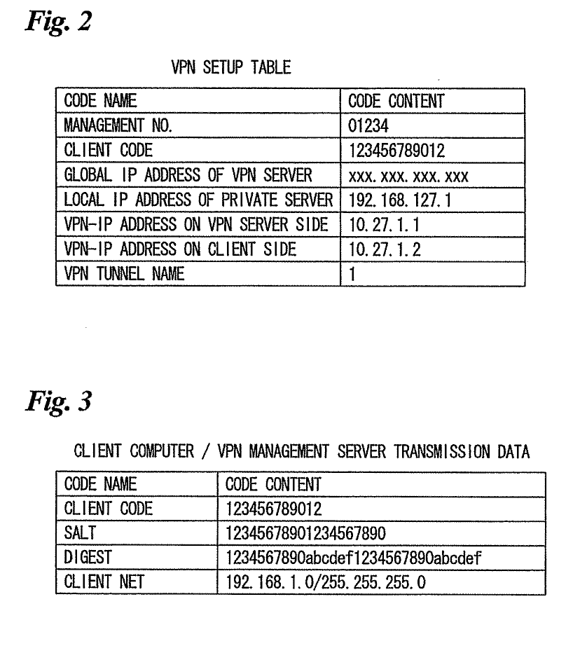

FIG. 2 is an example of a VPN setup table that has been stored in a VPN setup database 12. A data of VPN setup table has been specified for every client computer 1.

The VPN setup table includes a management number, a client code, the global IP address of the VPN server 13, a private server local IP address, a VPN-IP address on the side of the VPN server, a VPN-IP address on the side of the client and a VPN tunnel name.

The management number is a number for identifying the data of the VPN setup table. The client code is for identifying the client computer 1. The global IP address of the VPN server is the address of the VPN server 13 in a case where the VPN server 13 is accessed via the Internet 2. The private server local IP address is the address of the private server 15 of LAN 16. The VPN-IP address on the VPN server side is the address of the VPN management server 11 in a case where the client computer 1 and VPN server 13 communicate via the VPN tunnel 3. The VPN-IP address on the client side is the address of the client computer 1 in a case where the client computer 1 and VPN server 13 communicate utilizing the VPN tunnel 3. The VPN tunnel name is for identifying each VPN tunnel in a case where a plurality of the VPN tunnels 3 exist.

With reference again to FIG. 1, the client computer 1 issues a VPN setup request to the VPN management server 11 before it communicates with the VPN server 13 using the VPN (that is, before it communicates using the VPN tunnel 3).

FIG. 3 is an example of client computer/VPN management server transmission data transmitted from the client computer 1 to the VPN management server 11 in the VPN setup request.

The client computer/VPN management server transmission data includes a client code, a salt, a digest (authentication code) and a client net. The salt is a random numeral string (character string) generated in the client computer 1. The digest is the result of computing the client code and salt and then performing encryption (hashing) using the VPN management server key. The client net is the address of the network to which the client computer 1 belongs and the address of a subnet mask. It goes without saying that the VPN management server key is stored in the VPN management server 11 and client computer 1 and that the digest is generated using this VPN management server key.

When the VPN setup request from the client computer 1 is received by the VPN management server 11, the latter issues a VPN/FW/NAT setup request to the VPN server 13.

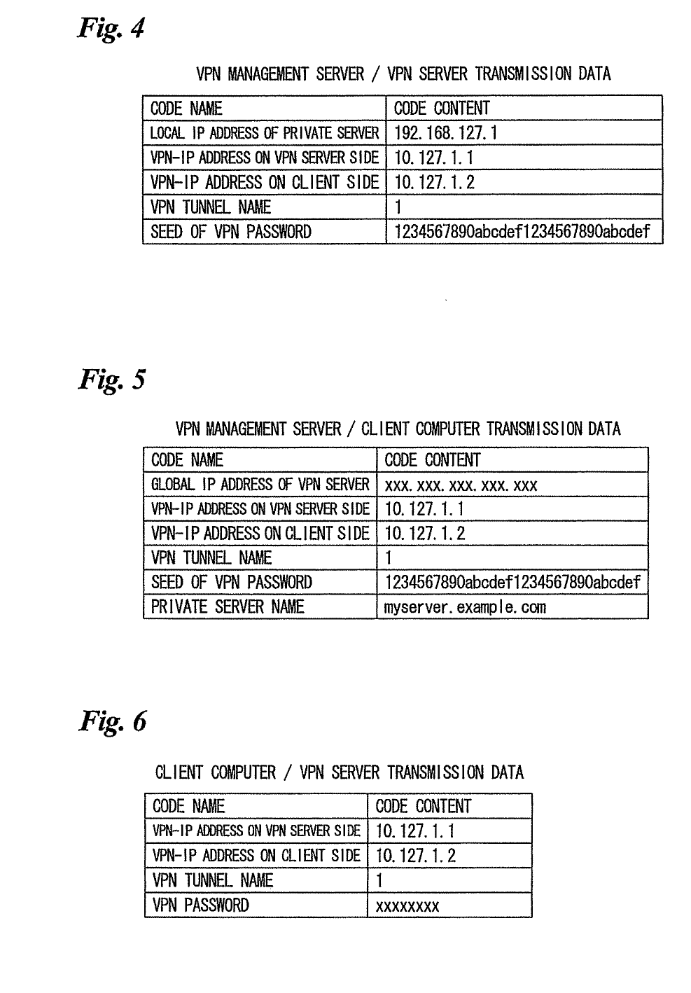

FIG. 4 is an example of VPN management server/VPN server transmission data transmitted from the VPN management server 11 to the VPN server 13 in the VPN/FW/NAT setup request.

The VPN management server/VPN server transmission data includes the local IP address of the private server 15, the VPN-IP address on the VPN server side, the VPN-IP address on the client side, the VPN tunnel name and the seed of the VPN password. The seed of the VPN password is a character string for generating a VPN password. The VPN password is for verifying whether the client computer 1 has authorization to utilize the VPN in a case where the client computer 1 and VPN server 13 communicate utilizing the VPN tunnel 3.

With reference again to FIG. 1, the VPN management server 11 issues a VPN setup response to the client computer 1 in response to the VPN setup request from the client computer 1 to the VPN management server 11.

FIG. 5 is an example of VPN management server/client computer transmission data transmitted from the VPN management server 11 to the client computer 1 in the VPN setup response.

The VPN management server/client computer transmission data includes the global IP address of the VPN server, the VPN-IP address on the VPN server side, the VPN-IP address on the client side, the VPN tunnel name, the seed of the VPN password and the private server name.

With reference again to FIG. 1, the client computer 1 issues the VPN server 13 a VPN connection request in response to the VPN setup response from the VPN management server 11 to the client computer 1.

FIG. 6 illustrates an example of client computer/VPN server transmission data transmitted from the client computer 1 to the VPN server 13 in the VPN connection request.

The client computer/VPN server transmission data includes the VPN-IP address of the VPN server side, the VPN-IP address on the client side, the VPN tunnel name and the VPN password. The VPN password has been generated from the seed of the VPN.

With reference again to FIG. 1, communication utilizing the VPN tunnel 3 is performed between the client computer 1 and VPN server 13 when it is verified in the VPN server 13 that the VPN password that has been transmitted from the client computer 1 is a valid password. By virtue of the NAT (Network Address Translation) function of the VPN server 13, data that has been transmitted from the client computer 1 is sent to the private server 15 via the VPN server 13 and data that has been transmitted from the private server 15 is sent to the client computer 1 via the VPN server 13, whereby the client computer 1 and private server 15 can communicate. The details will become clear from the description below.

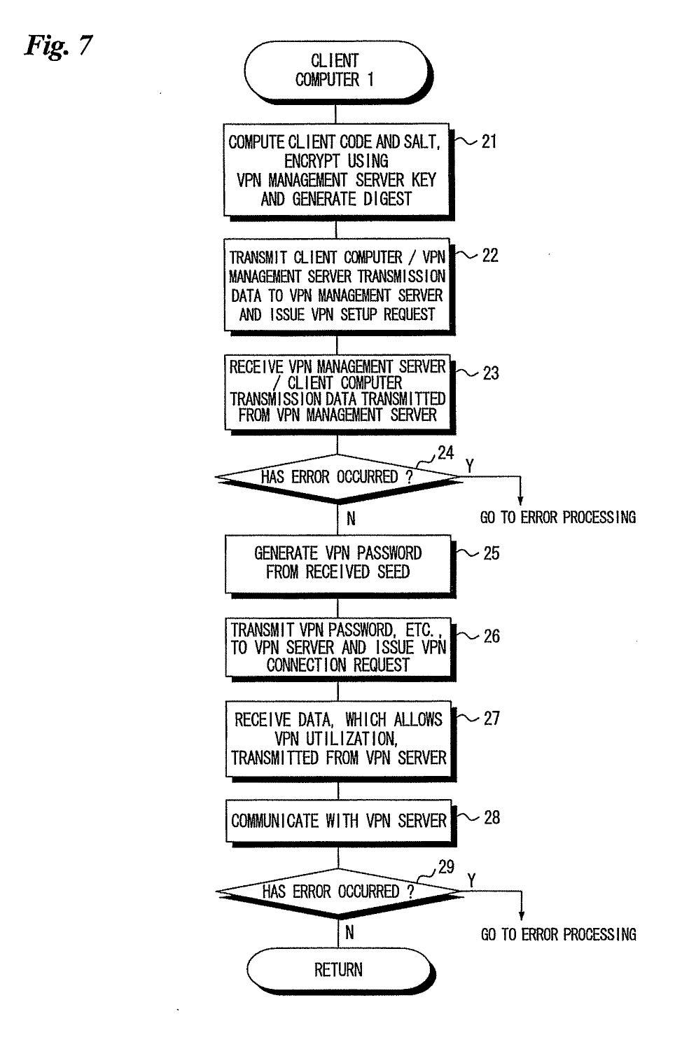

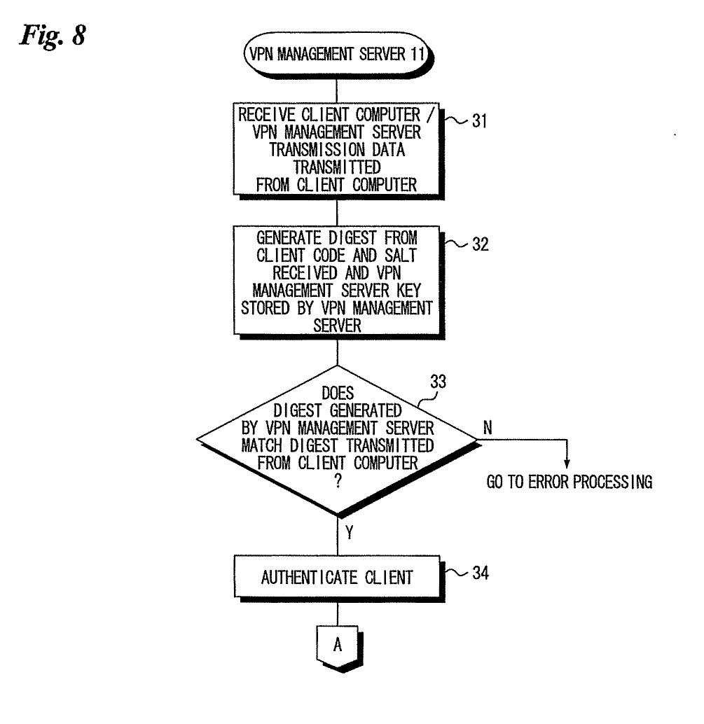

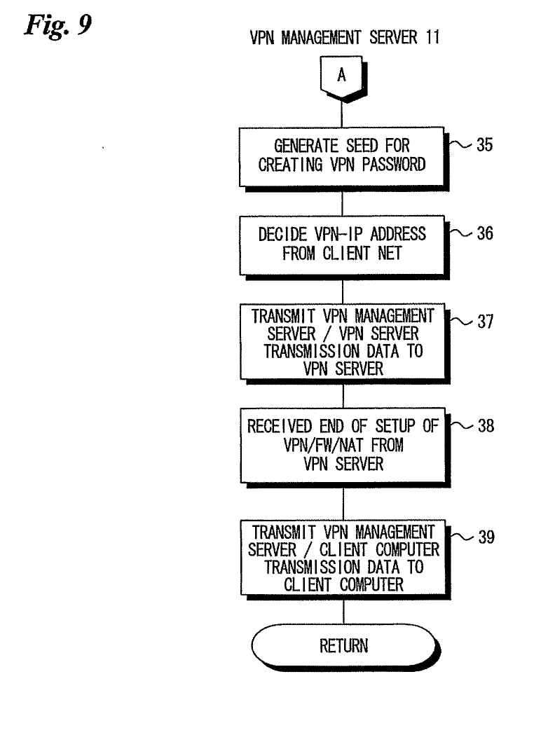

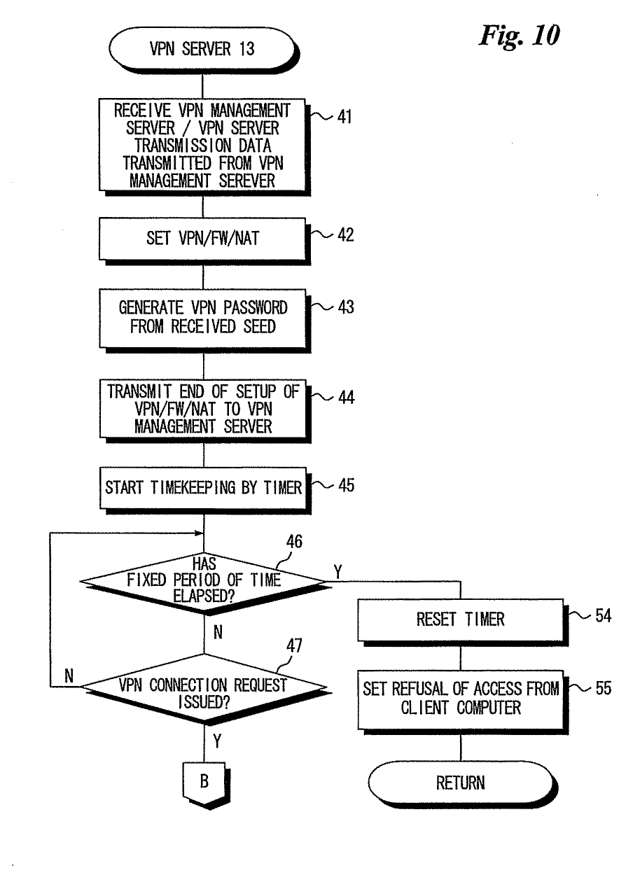

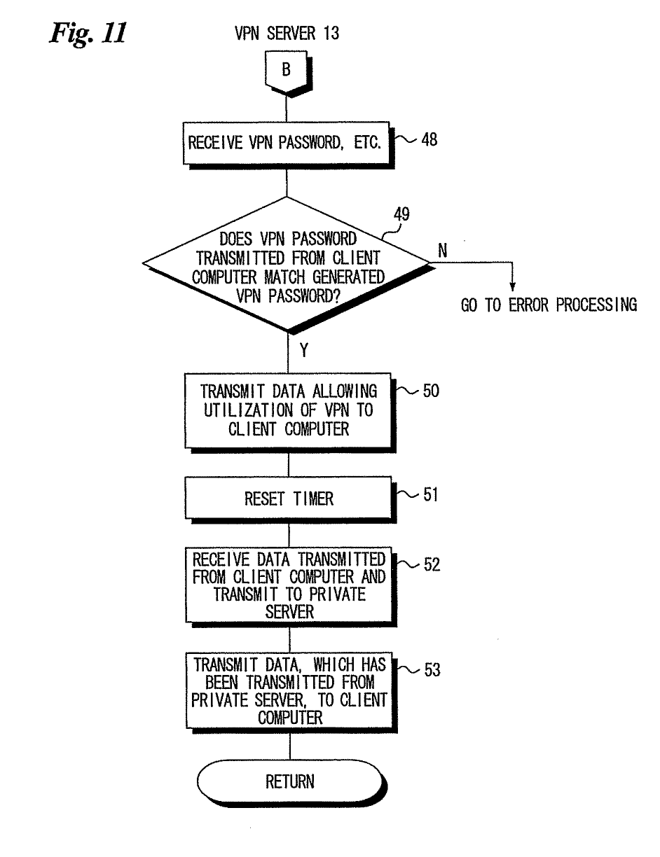

FIGS. 7 to 11 are flowcharts illustrating the processing executed in the VPN system. FIG. 7 is a flowchart illustrating processing executed by the client computer 1, and FIGS. 8 and 9 are flowcharts illustrating processing executed by a VPN management server 11. FIGS. 10 and 11 are flowcharts illustrating processing executed by the VPN server 13.

As described above, before the VPN setup request is issued to the VPN management server 11, the client code and salt are computed in the client computer 1 (or use is made of an encryption code which is at least one of the client code and salt) and a digest (authentication code) is generated in accordance with a prescribed algorithm (second prescribed algorithm) using the VPN management server key (FIG. 7, step 21). The client computer/VPN management server transmission data, which includes the client code, salt, the generated digest and the client net, as mentioned above, is transmitted from the client computer 1 to the VPN management server 11 upon being encrypted as by SSL (Secure Sockets Layer), and the VPN setup request is sent from the client computer 1 to the VPN management server 11 (FIG. 7, step 22).

When the client computer/VPN management server transmission data transmitted from the client computer 1 is received by the VPN management server 11 (FIG. 8, step 31), the latter decrypts the client code and salt contained in the received data and, using the VPN management server key stored in the VPN management server 11, subsequently generates a digest in accordance with an algorithm (the second prescribed algorithm) identical with the prescribed algorithm that generates the digest in the client computer 1 (FIG. 8, step 32). The digest generated in the VPN management server 11 and the digest transmitted from the client computer 1 are checked to determine whether they match. If the do match (“YES” at step 33 in FIG. 8), then the client is authenticated by reason of the fact that the client computer 1 that issued the VPN setup request to the VPN management server 11 is a user authorized to utilize the VPN system (FIG. 8, step 34). If the two digests do not match (“NO” at step 33 in FIG. 8), then the client is not authenticated and prescribed error processing is executed.

In a case where a common key is stored in the client computer 1 and VPN management server 11 by communicating the common key between the client computer 1 and VPN management server 11 and client authentication is performed using the common key, there are instances where leakage of the common key occurs when it is communicated and a third party may be authenticated as a client through use of the leaked common key. In this embodiment, however, a digest generated in the client computer 1 using a prescribed algorithm is transmitted without transmitting a common key, a digest is generated in the VPN management server 11 as well using an algorithm identical with the prescribed algorithm, and whether the digest transmitted from the client computer 1 and the digest generated in the VPN management server 11 match is verified. This embodiment is such that even if the client code and VPN management server key, etc., are stolen, client authentication will not be achieved unless the prescribed algorithm for generating the digests is analyzed. Security is enhanced as a result.

Further, the client computer 1 can also authenticate the VPN management server 11 by utilizing the SSL. This makes possible mutual authentication, namely authentication of the client computer 1 and authentication of the VPN management server 11. In such case the client computer 1 would possess the root certificate of the SSL.

Next, the VPN management server 11 generates a seed, namely a character string for creating a VPN password (FIG. 9, step 35). Further, using the client net that it has received, the VPN management server 11 decides the VPN-IP address range and the above-mentioned client-side and server-side VPN-IP addresses so as not to conflict with the private IP range to which the client computer 1 already belongs and the private IP address range to which the private server 15 already belongs (FIG. 9, step 36). When the client-side VPN-IP address is decided, the VPN management server 11 transmits the VPN management server/VPN server transmission data to the VPN server 13, as mentioned above (FIG. 9, step 37).

Upon receiving the VPN management server/VPN server transmission data transmitted from the VPN management server 11 (FIG. 10, step 41), the VPN server 13 uses the received VPN management server/VPN server transmission data to set up the VPN, set up the FW (firewall) and set up the NAT (i.e., to perform the VPN/FW/NAT setup) (FIG. 10, step 42). Setting up the VPN involves defining a VPN tunnel specified by the VPN tunnel name contained in the VPN management server/VPN server transmission data. Further, in the setting up of the VPN, the VPN tunnel name, VPN-IP address on the VPN server side, the VPN-IP address on the client side and the VPN password are also placed in the VPN/FW/NAT setup database 14. Setting up the FW is achieved by a setup that allows a connection from the global IP address of the client computer 1. Since the VPN management server 11 communicates with the client computer 1 by utilizing a global IP address, the global IP address of the client computer 1 is known. The VPN server 13 would therefore transmit the global IP address of the client computer 1 from the VPN management server 11. Setting up the NAT involves achieving a setup that converts the VPN-IP address on the side of the VPN server to the local IP address of the private server 15 in one-to-one correspondence. The firewall may be set up not in the VPN server 13 but in a device other than the VPN server 13 if desired.

Next, the VPN server 13 generates a VPN password, in accordance with the prescribed algorithm (first prescribed algorithm), from the seed received (FIG. 10, step 43). Upon doing so, the VPN server 13 transmits data, which indicates the end of setup of the VPN/FW/NAT, to the VPN management server 11 (FIG. 10, step 44). Furthermore, the VPN server 13 starts measuring time by a timer incorporated within the VPN server 13 (FIG. 10, step 45).

Upon receiving the data transmitted from the VPN server 13 indicating the end of setup of the VPN/FW/NAT (FIG. 9, step 38), the VPN management server 11 transmits VPN management server/client computer transmission data to the client computer 1 (FIG. 9, step 39).

Upon receiving the VPN management server/client computer transmission data transmitted from the VPN management server 11 (FIG. 7, step 23), the client computer 1 determines whether an error such as a client authentication failure has occurred in the VPN management server 11 (FIG. 7, step 24). If an error occurs (“YES” at step 24 in FIG. 7), prescribed error processing is executed. If an error does not occur (“NO” at step 24 in FIG. 7), then, from the seed contained in the VPN management server/client computer transmission data, the client computer 1 generates a VPN password using an algorithm (the first prescribed algorithm) identical with the prescribed algorithm for generating the VPN password in the VPN server 13 (FIG. 7, step 25).

Next, the client computer 1 accesses the global IP address of the VPN server 13, transmits client computer/VPN server transmission data and issues a VPN connection request to the VPN server 13 (FIG. 7, step 26). The firewall of the VPN server 13 has been set up so as to allow access from the global IP address of the client computer 1, as set forth above.

If the VPN server 13 receives a VPN connection request from the client computer 1 (“YES” at step 47 in FIG. 10) before a fixed period of time elapses from the start of timekeeping by the timer (“NO” at step 46 in FIG. 10), then the VPN server 13 receives the client computer/VPN server transmission data that has been transmitted from the client computer 1 (FIG. 11, step 48). The VPN server 13 determines whether the VPN password corresponding to the VPN tunnel name contained in the client computer/VPN server transmission data matches the VPN password already generated in the VPN server 13 in correspondence with the VPN tunnel name (FIG. 11, step 49). If the two passwords match (“YES” at step 49 in FIG. 11), then data allowing VPN utilization by reason of the fact that the client has been authenticated is transmitted from the VPN server 13 to the global IP address of the client computer 1 (FIG. 11, step 50). When the client computer/VPN server transmission data is transmitted from the client computer 1 to the VPN server 13, the global IP address of the client computer 1 is appended thereto and transmitted to the VPN server 13, and it goes without saying that the VPN server 13 is capable of recognizing the IP address. Further, the timer is reset (FIG. 11, step 51).

When the data transmitted from the VPN server 13 allowing utilization of the VPN is received by the client computer 1 (FIG. 7, step 27), the client computer 1 and the VPN server 13 perform VPN communication utilizing the VPN tunnel 3, with the client computer 1 using the VPN-IP address on the side of the client computer and the VPN server 13 using the VPN-IP address on the VPN server side (FIG. 7, step 28). Next, the client computer 1 determines whether an error such as a client authentication failure has occurred in the VPN management server 11 (FIG. 7, step 29). If an error occurs (“YES” at step 29 in FIG. 7), prescribed error processing is executed.

When data is transmitted from the client computer 1 to the VPN-IP address on the VPN server side 13 via the VPN tunnel 3, the data is received. The address at the transmission destination of the received data is changed from the VPN-IP address on the VPN server side to the local address of the private server 15. The data transmitted from the client computer 1 and received by the VPN server 13 is transmitted to the changed local address of the private server 15 (FIG. 11, step 52).

The data that has been transmitted from the VPN server 13 is transmitted to the private server 15 via the LAN 16 and is received by the private server 15. Data that is in response to the receipt of the data is transmitted from the private server 15 to the VPN server 13.

Upon receiving the data transmitted from the private server 15, the VPN server 13 transmits the received data to the client-side VPN-IP address of the client computer 1 via the VPN tunnel 3, with the address of the source of the transmission being changed to the VPN-IP address on the VPN server side (FIG. 11, step 53). Thereafter, and in similar fashion, the private server 15 communicates with the client computer 1 via the VPN tunnel 3 and VPN server 13.

In order to communicate utilizing the VPN tunnel 3 in the foregoing embodiment, the client computer 1 generates a VPN password from a seed using a prescribed algorithm, the VPN server 13 also generates a VPN password using an algorithm identical with the prescribed algorithm utilized in the client computer 1 and authentication is achieved when the two VPN passwords coincide. Even if leakage of the seed occurs, communication utilizing the VPN tunnel 3 cannot be performed unless the prescribed algorithm is analyzed. This makes it possible to achieve a high level of security.

Even if a fixed period of time (e.g., several minutes) elapses from the start of timekeeping by the timer of the VPN server 13, the timer is reset (FIG. 10, step 54) unless the client computer 1 issues a VPN connection request (“YES” at step 46, “NO” at step 47 in FIG. 10), and the firewall function of the VPN server 13 is set so as to refuse access even if a VPN connection request is subsequently issued from the client computer 1 (FIG. 10, step 55). Since the VPN connection request is accepted only within a fixed period of time from start of timekeeping by the timer, it is possible to prevent a third-party computer from utilizing the VPN tunnel 3 with respect to the VPN server 13 as by an indiscriminate brute-force attack on accounts with regard to the VPN server 13.

It may be so arranged that in a case where a communication problem or authentication failure or the like occurs between the client computer 1 and VPN management server 11 or VPN server 13 in the foregoing embodiment, a message so notifying the user of the client computer 1 is displayed on the display screen of the display unit of client computer 1 and the user of the client computer 1 is prompted to issue the connection request again. If the user who operates the client computer 1 is not present, processing for performing the re-connection would be executed upon elapse of a fixed or random period of time.

As many apparently widely different embodiments of the present invention can be made without departing from the spirit and scope thereof, it is to be understood that the invention is not limited to the specific embodiments thereof except as defined in the appended claims.

What is claimed is:

1. A VPN system comprising a VPN management server, a client computer and a VPN server, wherein said VPN management server includes:
a seed generating device for generating a seed, which is a character string for creating a VPN password for verifying authorization to utilize a VPN by which said client computer communicates with said VPN server via a VPN tunnel;
a first seed transmitting device for transmitting the seed generated by said seed generating device to said client computer via the Internet; and
a second seed transmitting device for transmitting the seed generated by said seed generating device to said VPN server via a LAN;
said client computer includes:
a first VPN password generating device for generating a VPN password by a first prescribed algorithm using the seed transmitted from said first seed transmitting device of said VPN management server; and
a VPN password transmitting device for transmitting the VPN password generated by said first VPN password generating device to said VPN server; and
said VPN server includes:
a second VPN password generating device for generating a VPN password by an algorithm identical with the first prescribed algorithm, by which said client computer generates the VPN password by said first VPN password generating device, using the seed transmitted from said second seed transmitting device of said VPN management server; and
a VPN authentication device for allowing utilization of the VPN by said client computer in response to a match between the VPN password generated by said second VPN password generating device and the VPN password transmitted from said VPN password transmitting device of said client computer.

2. The system according to claim 1, wherein said client computer further includes:
a first authentication code generating device for generating an authentication code obtained by encrypting a prescribed code for encryption by a second prescribed algorithm using a VPN management server key specific to said VPN management server; and
a code transmitting device for transmitting the authentication code generated by said first authentication code generating device and the prescribed code for encryption to said VPN management server;
said VPN management server further includes:
a VPN management server key storage device for storing the VPN management server key;
a second authentication code generating device for generating an authentication code obtained by encrypting the prescribed code for encryption, which has been transmitted from said code transmitting device and used in generating the authentication code in said first authentication code generating device, by an algorithm identical with the second prescribed algorithm in said first authentication code generating device using the VPN management server key that has been stored in said VPN management server key storage device; and
a client authentication device for authenticating the client by a match between the authentication code generated by said second authentication code generating device and the authentication code transmitted from said authentication code transmitting device of said client computer; and
said first seed transmitting device of said VPN management server transmits the seed, which has been generated by said seed generating device, to said client computer via the Internet, in response to authentication of the client by said client authentication device.

3. The system according to claim 2, wherein the prescribed code for encryption is at least one of a client code, which identifies said client computer, and a salt, which is a random character string.

4. A method of controlling operation of a VPN system comprising a VPN management server, a client computer and a VPN server, said method comprising steps of:
said VPN management server generating a seed, which is a character string for creating a VPN password for verifying authorization to utilize a VPN by which said client computer communicates with said VPN server via a VPN tunnel;
transmitting the seed generated to said client computer via the Internet; and
transmitting the seed generated to said VPN server via a LAN;
said client computer generating a VPN password by a first prescribed algorithm using the seed transmitted from said VPN management server; and
transmitting the VPN password generated to said VPN server; and
said VPN server generating a VPN password by an algorithm identical with the first prescribed algorithm, by which said client computer generates the VPN password, using the seed transmitted from said VPN management server; and
allowing utilization of the VPN by said client computer in response to a match between the VPN password generated and the VPN password transmitted from said client computer.
